(19) United States
(12) Patent Application Publication
(10) Pub. No.: US 2007/0075160 A1
(43) Pub. Date: Apr. 5, 2007

(54) Fluid injection valve

(75) Inventors: Yusuke Hongo, Kariya-city (JP); Masaaki Kato, Kariya-city (JP); Shigeo Nomura, Toyohashi-city (JP); Yoshiaki Nishijima, Toyokawa-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/446,963

(22) Filed: Jun. 6, 2006

(30) Foreign Application Priority Data
Apr. 12, 2006 (JP) 2006-110183
Jun. 6, 2005 (JP) 2005-166226

(51) Int. Cl. F02M 41/16

(52) U.S. Cl. 239/96; 239/533.8; 239/533.9

(57) ABSTRACT

A fluid injection valve has an outer and inner needles provided with an opening-side interlock and a closing-side interlock. The opening-side interlock engages the outer needle with the inner needle to limit a relative displacement between the outer and inner needles within a first predetermined distance during an opening operation of the outer and inner needles to open an outer and inner injection holes. The closing-side interlock engages the outer needle with the inner needle to limit the relative movement between the outer and inner needles within a second predetermined distance during a closing operation of the outer and inner needles.

### CROSS REFERENCE TO RELATED APPLICATION

This application is based upon and claims the benefit of priority of Japanese Patent Applications No. 2005-166226 filed on Jun. 6, 2005 and No. 2006-110183 filed on Apr. 12, 2006, the contents of which are incorporated herein by reference.

### FIELD OF THE INVENTION

The present invention relates to a fluid injection valve suitable for a vehicular fuel injection system.

### BACKGROUND OF THE INVENTION

US-2004-0129804-A1 and its counterpart WO-03-069151-A1 disclose a fuel injection valve provided with: an outer needle that is installed in a valve body to open and close outer injection holes of the valve body; an inter needle that is installed in the outer needle to open and close second injection holes of the valve body; a back pressure chamber that accumulates a pressure working on the outer and inner needles to control movements of the outer and inner needles in accordance with a variation of the pressure in the backpressure chamber; and a pressure control valve that regulates the pressure in the backpressure chamber.

In the above fuel injection valve, the inner needle is installed inside of the outer needle. Therefore, when the pressure in the backpressure chamber is decreased, firstly the outer needle moves to its opening side, and then the inner needle moves to its opening side. Accordingly, the fuel injection valve is provided with two or more tiers of a fuel injection ratio in its injection starting time.

However, a first drawback occurs due to a construction of the fuel injection valve that: the inner needle has a cylindrical shape with a constant diameter over its length from its one end portion to the other end portion; and the outer needle includes a through bore installing the inner needle therein and an engaging portion having a diameter smaller than a bore diameter of the through bore to be engaged with the inner needle when the inner needle is lifted upward. In this construction, the movement of the inner needle is determined in accordance with pressures acting on the one and the other end portions of the inner needle. Accordingly, the inner needle starts moving to its opening side at a timing irrelevant to the movement of the outer needle in a transition of the outer and inner needles from a closing position to close the outer and inner injection holes to an opening position to open the outer and inner injection holes. As a result, the injection ratio of the fuel injection valve is unstable in a first half stage of each fuel injection operation.

Similarly, the construction of the fuel injection valve causes a second drawback that the inner needle starts moving at an unstable timing in a transition of the outer and inner needles from the opening position to the closing position. That is, sometimes the inner needle starts moving in advance of the outer needle, and sometimes the inner needle does not start moving in advance of the outer needle, to make the injection ratio of the fuel injection valve unstable in a latter half stage of each fuel injection operation.

Japanese patent application No. 2004-139326, which is filed by the assignee of the present invention and publicated later as JP-2005-320904-A, discloses a fuel injection valve schematically shown in FIG. 11. The fuel injection valve overcomes the above-mentioned first drawback. The fuel injection valve includes: a cylindrically-shaped outer needle 600; and an inner needle 700 that is slidably installed in the outer needle 600 and provided with a large diameter portion 710 in its counter injection hole-side end portion. When the outer and inner injection holes 220, 230 are closed by the outer and inner needles 600, 700, the counter injection hole-side end portion 610 of the outer needle 600 and the inner needle 700 form a clearance L therebetween.

When a control valve (not shown) decreases a fuel pressure in the backpressure chamber 300, firstly the outer needle 600 starts moving to an opening side to open the outer injection holes 220. Then, the outer needle 600 is moved by a distance as much as the clearance L, to bring the counter injection hole-side end portion 610 of the outer needle 600 in contact with the large diameter portion 710 of the inner needle 700. After that, the outer needle 600 further moves together with the inner needle 700 to the opening side to open the second injection holes 230. Accordingly, the movement of the inner needle 700 is interlocked with the movement of the outer needle 600, to stabilize a timing to start moving the inner needle 700 and to realize a demanded injection ratio in a first half stage of each fuel injection operation, relative to the conventional fuel injection valve.

However, the fuel injection valve according to Japanese patent application No. 2004-139326 does not overcome the above-mentioned second drawback. The outer needle 600 has a cylindrical shape, so that a timing to start moving the inner needle 600 is unstable in a transition from the opening position to open the outer and inner injection holes 220, 230 to the closing position to close the outer and inner injection holes 220, 230. That is, sometimes the outer needle 600 starts moving in advance of the inner needle 700, and sometimes the outer needle 600 does not start moving in advance of the inner needle 700. Accordingly, the fuel injection valve shown in FIG. 11 cannot stabilize the injection ratio in a latter half stage of each fuel injection operation.

### SUMMARY OF THE INVENTION

The present invention is achieved in view of the above-described issues, and has an object to provide a fluid injection valve that has a stable fuel injection ratio from a first half stage to a latter half stage of each fuel injection operation.

The fluid injection valve has a valve body, an outer needle, an inner needle, a backpressure chamber and a pressure control valve. The valve body has an outer injection hole and an inner injection hole respectively for injecting fluid therefrom. The outer needle is installed in the valve body to slide in an axial direction to open and close the outer injection hole. The inner needle is installed in a longitudinal bore of the outer needle in the axial direction to open and close the inner injection hole. The backpressure chamber accumulates a backpressure acting on the outer and inner needles. The pressure control valve regulates the backpressure to control movements of the outer and inner needles.

The outer needle and the inner needle have an opening-side interlock and a closing-side interlock. The opening-side interlock engages the outer needle with the inner needle to limit a relative displacement between the outer and inner needles within a first predetermined distance during an opening operation of the outer and inner needles from a closing position to close the outer and inner injection holes to an opening position to open the outer and inner injection holes. The closing-side interlock engaging the outer needle with the inner needle to limit the relative movement between the outer and inner needles within a second predetermined distance during a closing operation of the outer and inner needles from the opening position to the closing position.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1 is a diagram schematically showing an accumulator fuel injection apparatus and a fluid injection valve according to a first embodiment of the present invention;

FIG. 2 is a cross-sectional view showing a principal portion of the fluid injection valve according to the first embodiment;

FIG. 3 is a cross-sectional view showing a leading end portion of the fluid injection valve according to the first embodiment;

FIG. 4 is a diagram showing a first operational state of the fluid injection valve according to the first embodiment;

FIG. 5 is a diagram showing a second operational state of the fluid injection valve according to the first embodiment;

FIG. 6 is a diagram showing a third operational state of the fluid injection valve according to the first embodiment;

FIG. 7 is a diagram showing a fourth operational state of the fluid injection valve according to the first embodiment;

FIG. 8A is a timing chart showing a variation of a driving pulse that is sent by an ECU to control an operation of a piezoelectric device in the fluid injection valve according to the first embodiment;

FIG. 8B is a timing chart showing a variation of a pressure in a backpressure chamber in the fluid injection valve according to the first embodiment;

FIG. 8C is a timing chart showing variations of traveling distances of an outer and inner needles in the fluid injection valve according to the first embodiment;

FIG. 8D is a timing chart showing a variation of an injection ratio of the fluid injection valve according to the first embodiment;

FIGS. 9A and 9B are diagrams showing an assembly process of the fluid injection valve to install the inner needle into the outer needle;

FIG. 10 is a cross-sectional view showing a principal portion of a fluid injection valve according to a second embodiment of the present invention; and

FIG. 11 is a cross-sectional view showing a principal portion of a related fluid injection valve.

### DETAILED DESCRIPTION OF PREFERRED EMBODIMENTS

### First Embodiment

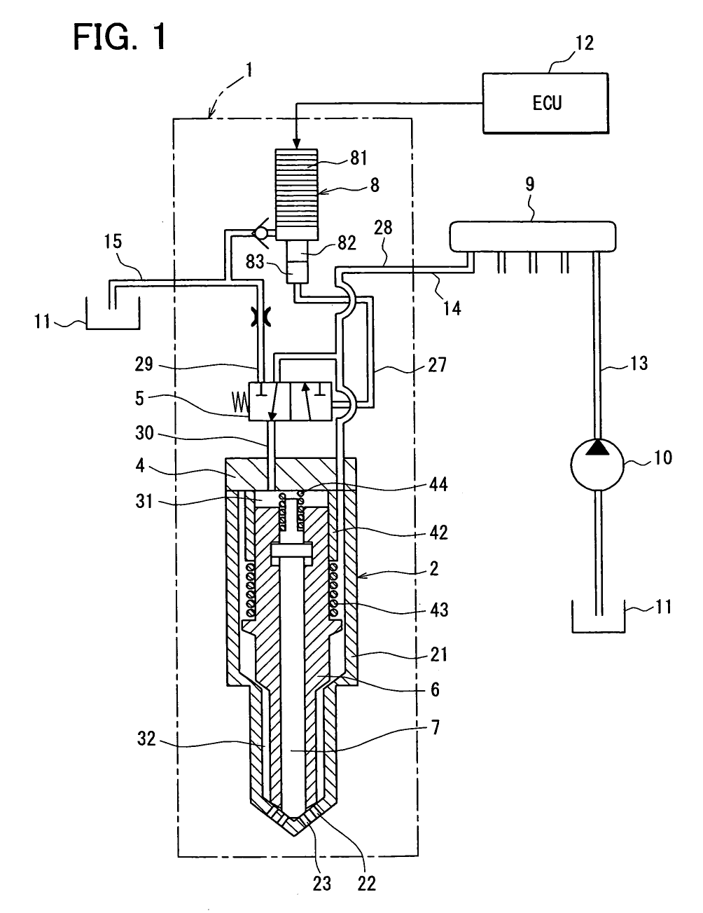

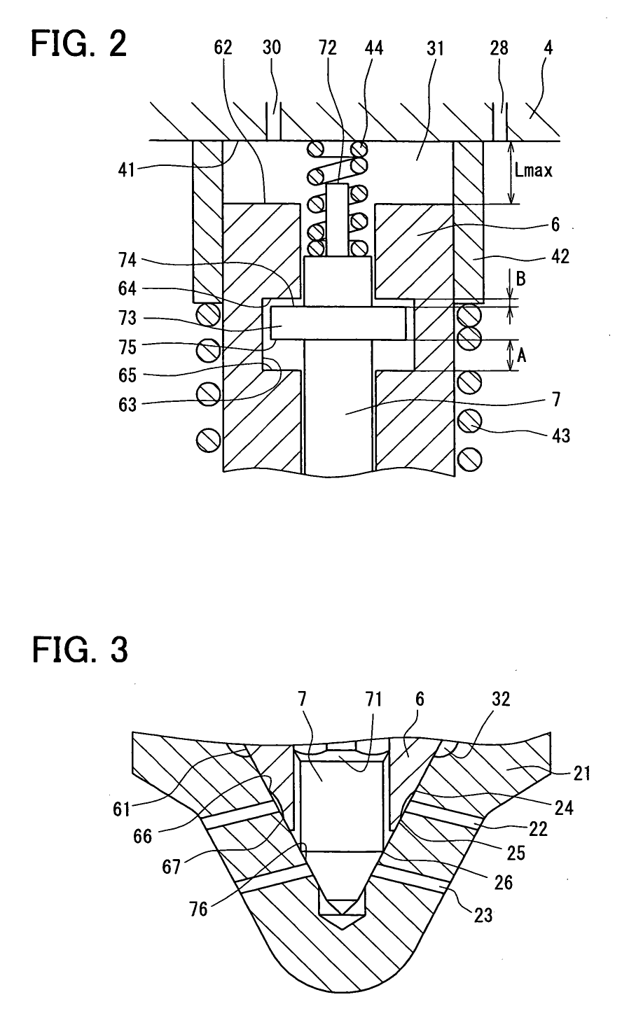

A fuel injection valve according to a first embodiment of the present invention is described in the following, referring to FIGS. 1 to 8.

The fuel injection valve 1 is incorporated in a common rail fuel injection system for an internal combustion engine such as a diesel engine, which is hereinafter referred to just as “engine”. The fuel injection valve 1 is installed on each cylinder of the engine, to inject directly into the cylinder.

The common rail fuel injection system includes: a fuel injection valve 1; a common rail 9; a fuel pump 10; an electronic control unit (ECU) 12; the fuel pipes 13, 14; a fuel discharge pipe 15 and a fuel tank 11. One end of the fuel pipe 14 is connected to the fuel injection valve 1, and the other end of the fuel pipe 14 is connected to the common rail 9. One end of the fuel pipe 13 is connected to the common rail 9, and the other end of the fuel pipe 13 is connected to the fuel tank 11. A fuel pump 10 is provided on a pipe way of the fuel pipe 13. One end of the fuel discharge pipe 15 is connected to the fuel injection valve 1, and the other end of the fuel discharge pipe 15 is connected to the fuel tank 11.

The fuel pump 10 is a plunger-type supply pump that is driven by the engine. The fuel pump 10 pressurizes the fuel drawn from the fuel tank 11 to a predetermined pressure, which is configured in accordance with a driving state and other factors. The pressurized high-pressure fuel is supplied through the fuel pipe 13 to the common rail 9.

The common rail 9 is an accumulator for accumulating fuel at a pressure in accordance with the driving state and other factors. The common rail 9 constantly supplies the high-pressure fuel to the fuel injection valve 1 through the fuel pipe 14. The ECU 12 calculates a fuel injection quantity in accordance with the driving state and other factors, and controls the fuel injection valve 1 so that the fuel injection valve 1 injects the calculated quantity of the fuel. The fuel discharge pipe 15 returns the excessive fuel, which is not injected by the fuel injection valve 1, to the fuel tank 11.

In the following is described a construction of the fuel injection valve 1, referring to FIGS. 1 to 3. The fuel injection valve 1 includes: an actuator portion 8; a three-way valve 5; and a nozzle portion 2. The fuel injection valve 1 is provided with passages of a control passage 27, a fuel supply passage 28, a fuel discharge passage 29 and a fuel passage 30. The passages is for supplying the high-pressure fuel from the above-mentioned fuel pipes 13, 14 to respective portions in the fuel injection valve 1, and for discharging excessive fuel out of the respective portions in the fuel injection valve 1. The three-way valve 5 corresponds to the pressure control valve according to the present invention.

The control passage 27 connects the actuator portion 8 to the three-way valve 5. The fuel supply passage 28 connects the nozzle portion 2 to the fuel pipe 14. The fuel supply passage 28 is branched on its way to be connected also to the three-way valve 5. The fuel passage 30 connects the three-way valve 5 to the nozzle portion 2. The fuel discharge passage 29 connects the three-way valve 5 to the fuel discharge pipe 15.

The actuator portion 8 includes a piezoelectric device 81 and a piston 82. The piezoelectric device 81 is electrically connected to the ECU 12. When the piezoelectric device 81 receives a driving pulse sent by ECU 12, the piezoelectric device 81 extends and shrinks in accordance with a magnitude of the driving pulse. The piezoelectric device 81 extends when the driving pulse is ON, and returns to its original length when the driving pulse is OFF. When the piezoelectric device 81 extends, an extension of the piezoelectric device 81 is transferred to the piston 82. On one end side of the piston 82 is formed a control chamber 83 that is filled with the fuel. Thus, an internal volume of the control chamber 83 varies in accordance with the extension and shrinkage of the piezoelectric device 81, to change the fuel pressure in the control chamber 83. The fuel pressure variation is-transferred via the control passage 27 to the three-way valve 5, to switch the three-way valve 5.

The three-way valve 5 switches between: a first position to communicate the fuel passage 30 with the fuel supply passage 28; and a second position to communicate the fuel passage 30 with the fuel discharge passage 29. When the three-way valve 5 is in the first position as shown in FIG. 1, the fuel passage 30 is communicated with the fuel supply passage 28, to supply the high-pressure fuel to the nozzle portion 2. When the three-way valve 5 is in the second position, the fuel passage 30 is communicated with the fuel discharge passage 29, to discharge the fuel out of the nozzle portion 2 to the fuel tank 11.

The nozzle portion 2 includes: a plate 4 and a nozzle body 21, which corresponds to the valve body according to the present invention. The nozzle body 21 is an approximately cylindrically-shaped part that has an opening in its upper end portion and a bottom in its lower end portion. The nozzle body 21 houses an outer needle 6, an inner needle 7, a cylinder 42, an outer spring 43, and an inner spring 44 therein. On the upper end portion of the nozzle body 21 is fixed the plate 4 by using a retaining nut and the like (not shown).

In a bottom portion of the nozzle body 21 are formed a plurality of outer injection holes 22 and a plurality of inner injection holes 23. The outer injection holes 22 are arranged on a first fictive circle that is coaxial to the central axis of the nozzle body 21, and the inner injection holes 23 are arranged on a second fictive circle that is coaxial to the central axis of the nozzle body 21 and has a diameter different from that of the first fictive circle. The first fictive circle on which the outer injection holes 22 are arranged is on a radially outer side of the second fictive circle on which the inner injection holes 23 are arranged.

The outer needle 6 is a valve head body, an injection hole-side end of which opens and closes the outer injection holes 22. The inner needle 7 is a valve head body, an injection hole-end of which opens and closes the inner injection holes 23. The outer needle 6 is an approximately cylindrically-shaped valve head body that has a hollow portion in a proximity to its central axis. The inner needle 7 is an approximately cylindrically-shaped valve head body that is slidably installed in the hollow portion of the outer needle 6.

On a counter injection hole-side of the outer needle 6 is provided an approximately cylindrically-shaped cylinder 42 for guiding the movement of the outer needle 6. A counter injection hole-side end portion of the cylinder 42 is in contact with the plate surface 41. An injection hole-side end portion of the cylinder 42 and the outer needle 6 sandwich an outer spring 43 therebetween, to generate an urging force to urge the outer needle 6 toward the outer injection holes 22. The plate surface 41 of the plate 4 and the inner needle 7 sandwich an inner spring 44 therebetween to generate an urging force to urge the inner needle 7 toward the inner injection holes 23.

The nozzle body 21, which installs above-described respective parts therein, is also provided with several chambers therein. The interior wall of the nozzle body 21 and the circumferential surface of the outer needle 6 forms a nozzle chamber 32 therebetween. One end of the nozzle chamber 32 is communicated with a fuel supply passage 28 via a passage formed in the plate 4. The other end of the nozzle chamber 32 is communicated with the outer injection holes 22 and the inner injection holes 23. The high-pressure fuel is led through the fuel supply passage 28 into the nozzle chamber 32, and then injected out of the outer injection holes 22 and the inner injection holes 23.

In a counter injection hole-side end portion of the nozzle body 21 is defined a backpressure chamber 31 by a counter injection hole-side pressure-receiving surface 62 of the outer needle 6, a counter injection hole-side pressure-receiving surface 72 of the inner needle 7, the plate surface 41 and an interior wall of the cylinder 42. The backpressure chamber 31 is communicated with the fuel passage 30 via a passage formed in the plate 4.

The fuel passage 30 is communicated via the three-way valve 5 with the fuel supply passage 28 and the fuel discharge passage 29. As described above, switching operations of the three-way valve 5 regulates the pressure in the backpressure chamber 31. Further, pressures acting on the counter injection hole-side pressure-receiving surfaces 62, 72 of the outer and inner needles 6, 7 changes in accordance with the pressure in the backpressure chamber 31. Thus, a force to move the outer and needles 6, 7 toward the injection holes 22, 23 is adjusted by regulating the pressure in the backpressure chamber 31.

On an interior wall of the outer needle 6 is formed an annular groove 63, which corresponds to the depression according to the present invention. The annular groove 63 has: a bottom that is approximately in parallel to the circumferential surface of the outer needle 6; and sidewalls that are arranged side by side in an axial direction of the outer needle 6. A counter injection hole-side sidewall of the annular groove 63 is referred to as an upper end wall 64, and an injection hole-side sidewall of the annular groove 63 is referred to as a lower end wall 65. The upper end wall 64 corresponds to the second axial end interior surface according to the present invention, and the lower end wall 65 of the annular groove 63 corresponds to the first axial end interior surface according to the present invention.

On a sidewall of the inner needle 7 is formed a flange 73, which corresponds to the protrusion according to the present invention. A top of the protrusion of the flange 73 faces the bottom of the annular groove 63. A counter injection hole-side sidewall of the flange 73 is referred to as an upper surface 74, and an injection hole-side sidewall of the flange 73 is referred to as a lower surface 75. The upper surface 74 of the flange 73 corresponds to the second axial end surface according to the present invention. The lower surface 75 of the flange 73 corresponds to the first axial end surface according to the present invention.

The upper end wall 64 of the annular groove 63 and the upper surface 74 of the flange 73 face each other, and the lower end wall 65 of the annular groove 63 and the lower surface 75 of the flange 73 face each other. A thickness of the flange 73, i.e., a distance between the upper surface 74 of the flange 73 and the lower surface 75 of the flange 73 is smaller than a distance between the upper end wall 64 of the annular groove 63 and the lower end wall 65 of the annular groove 63.

When the outer and inner injection holes 22, 23 are closed by the outer and inner needles 6, 7, the upper surface 74 of the flange 73 and the upper end wall 64 of the annular groove 63 form a minute clearance B therebetween, and the lower surface 75 of the flange 73 and the lower end wall 65 of the annular groove 63 form a clearance A therebetween. At this time, a distance between the counter injection hole-side pressure-receiving surface 62 of the outer needle 6 and the plate surface 41 is Lmax, which is a maximum traveling distance of the outer needle 6. The clearance A is smaller than the distance Lmax, and the minute clearance B is much smaller than the clearance A.

As described above, when the outer and inner injection holes 22, 23 are closed by the outer and inner needles 6, 7, the annular groove 63 and the flange 73 form clearances A, B in the axial direction. Thus, even when entire lengths of the outer and inner needles 6, 7 vary with time, the clearances A, B absorb the variations of the entire lengths. Further, even when the outer and inner needles 6, 7 have dimensional deviations and tolerances, the clearances A, B absorb the dimensional deviations and tolerances. Accordingly, it is not necessary to form the outer and inner needles 6, 7 with extremely high processing accuracies beyond necessities, not to raise their working cost.

In the first embodiment, the outer needle 6 is provided with the annular groove 63, and the inner needle 7 is provided with the flange 73. By this construction, even when the outer needle 6 has a limitation in its outer diameter, it is possible to provide the annular groove 63 and the flange 73 without decreasing a strength of the inner needle 7 that is installed in the outer needle 6.

The injection hole-side end portion of the fuel injection valve 1 is mounted on the engine to be exposed to a combustion chamber of the engine, so that an outer diameter of the fuel injection valve 1 is set to a size as small as possible. Therefore, the strength of the outer needle 6 can be insufficient when the annular groove 63 is formed in the outer needle 6. In the first embodiment, the annular groove 63 is formed in a proximity of a counter injection hole-side end portion of the outer needle 6, in which the outer diameter of the outer needle 6 can be extended from that in the other portions. Accordingly, it is possible to minimize a strength decrease due to the annular groove 63 formed in the outer needle 6.

In the following are described constructions of the injection hole-side end portions of the outer and inner needles 6, 7, referring to FIG. 3. The nozzle body 21 has a first outer valve seat 24 that is formed on an upstream side of the outer injection holes 22, and a second outer valve seat 25 that is formed on a downstream side of the outer injection holes 22. The first outer valve seat 24 is for seating a first outer valve head portion 66 that is formed in the injection hole-side end portion of the outer needle 6. The second outer valve seat 25 is for seating a second outer valve head portion 67 that is formed in the injection hole-side end portion of the outer needle 6. The nozzle body 21 further has an inner valve seat 26 between the second outer valve seat 25 and the inner injection holes 23. The inner valve seat 26 is for seating an inner valve head portion 76 that is formed in the injection hole-side end portion of the inner needle 7.

The first outer valve seat 24 is located not to flow the high-pressure fuel from the nozzle chamber 32 to the outer injection holes 22 when the first outer valve head portion 66 is seated thereon. The second outer valve seat 25 is located not to flow the high-pressure fuel backward from a side of the inner needle 7 to the outer injection holes 22 when the second outer valve head portion 67 is seated thereon. The inner valve seat 26 is located not to flow the high-pressure fuel from the nozzle chamber 32 to the inner injection holes 23 when the inner valve head portion 76 is seated thereon.

The outer needle 6 is provided with an injection hole-side pressure-receiving surface 61 in its portion that is exposed to the nozzle chamber 32. The inner needle 7 is provided an injection hole-side pressure-receiving surface 71 in its injection-hole side portion, to receive a fuel pressure that is led from the nozzle chamber 32. When the fuel pressure that is led from the nozzle chamber 32 acts on the injection hole-side pressure-receiving surfaces 61, 71, the fuel pressure urges the outer and inner needles 6, 7 toward the counter injection hole-side. The movements of the outer and inner needles 6, 7 are determined in accordance with a balance between the fuel pressure acting on the injection hole-side pressure-receiving surfaces 61, 71 of the outer and inner needles 6, 7 and the fuel pressure acting on the counter injection hole-side pressure-receiving surfaces 62, 72 of the outer and inner needles 6, 7.

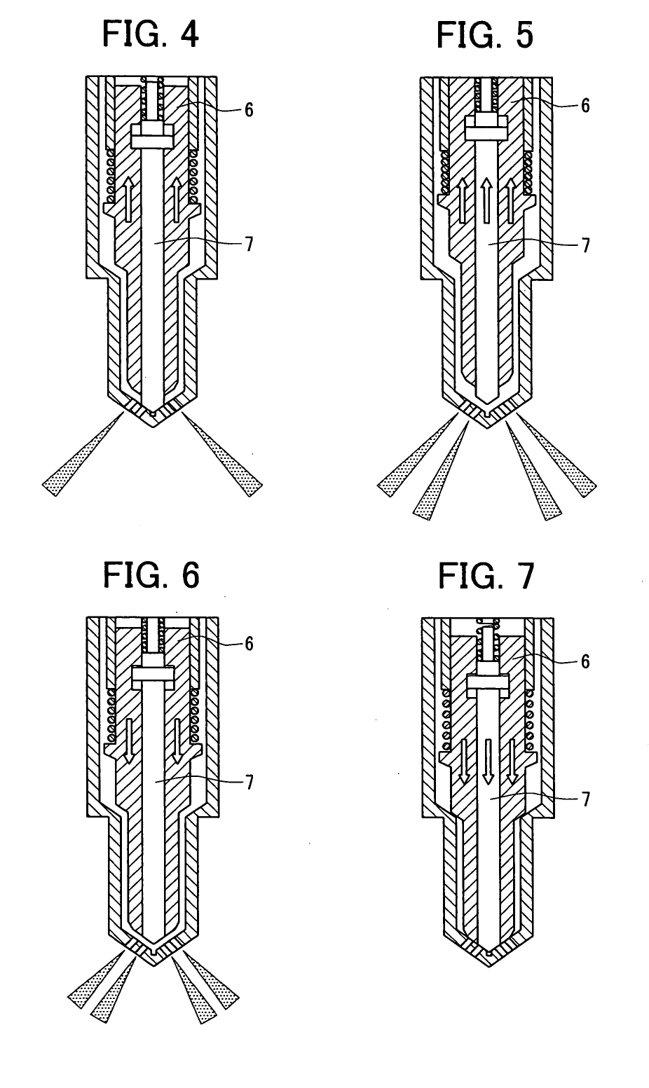

In the following are described actions of the outer and inner needles 6, 7, referring to FIGS. 4 to 7. When the three-way valve 5 is switched in the first position as shown in FIG. 1, the fuel passage 30 is connected to the fuel supply passage 28, so that the pressure in the backpressure chamber 31 is equal to the pressure in the common rail 9. The high-pressure fuel in the common rail 9 is supplied also to the nozzle chamber 32 through the fuel supply passage 28. That is, also the pressure in the nozzle chamber 32 is equal to the pressure in the common rail 9. Thus, both of the pressure-receiving surfaces 61, 62 are subjected to the pressures of the same magnitude. Accordingly, an area ratio of the pressure-receiving surfaces 61, 62 determines a force acting on the outer needle 6. In the first embodiment, an area of the counter injection hole-side pressure-receiving surface 62 is larger than an area of the injection hole-side pressure-receiving surface 61, so that the force urges the outer needle regularly toward the outer injection holes 22. Further, the outer needle 6 and the cylinder 42 sandwich the outer spring 43 therebetween, to move the outer needle 6 toward the outer injection holes 22. Thus, the first and second outer valve head portions 66, 67 are seated on the first and second valve seats 24, 25, to stop injecting the high-pressure fuel out of the outer injection holes 22. At this time, the pressure-receiving surface 71 of the inner needle 7 is not subjected to the high-pressure fuel in the nozzle chamber 32, so that the urging force of the inner spring 44 seats the inner valve head portion 76 on the inner valve seat 26, as shown in FIG. 4.

When the three-way valve 5 is switched in the second position to discharge the fuel in the backpressure chamber 31 outward through the fuel discharge passage 29 and the fuel discharge pipe 15, the pressure in the backpressure chamber 31 becomes smaller than the pressure of the high-pressure fuel. Thus, a pressure acting on the counter injection hole-side pressure-receiving surface 62 of the outer needle 6 decreases. Accordingly, the force urging the outer needle 6 away from the outer injection holes 22 exceeds the force urging the outer needle 6 toward the outer injection holes 22, so that the outer needle 6 moves away from the outer injection holes 22. As a result, the first and second outer valve head portions 66, 67 are lifted off the first and second valve seats 24, 25, to inject the high-pressure fuel out of the outer injection holes 22.

When the outer needle 6 is moved to the counter injection hole-side by a distance as much as the clearance A, the lower end wall 65 of the annular groove 63 comes in contact with the lower surface 75 of the flange 73. Then, the outer needle 6 moves together with the inner needle 7 until the counter injection hole-side pressure-receiving surfaces 62, 72 of the outer and inner needles 6, 7 come in contact with the plate surface 41 of the plate 4. At this time, the inner valve head portion 76 is lifted off the inner valve seat 26, to inject the high-pressure fuel not only out of the outer injection holes 22 but also out of the inner injection holes 23, as shown in FIG. 5.

When the three-way valve 5 is switched again in the first position to supply the high-pressure fuel to the backpressure chamber 31 through the fuel pipe 14 and the fuel supply passage 28, the pressure in the backpressure chamber 31 increases to the pressure of the high-pressure fuel to become approximately equal to the pressure in the nozzle chamber 32. Thus, the pressure acting on the counter injection hole-side pressure-receiving surface 62 of the outer needle 6 increases.

At this time, the counter injection hole-side pressure-receiving surface 72 of the inner needle 7 is in contact with the plate surface 41 of the plate 4, so that the counter injection hole-side pressure-receiving surface 72 of the inner needle 7 is not subjected to the pressure of the high-pressure fuel. Accordingly, only the outer needle 6 moves toward the outer injection holes 22, as shown in FIG. 6.

After that, the upper end wall 64 of the annular groove 63 comes in contact with the upper surface 74 of the flange 73. Then, the outer needle 6 moves together with the inner needle 7 until the first outer valve head portion 66, the second outer valve head portion 67 and the inner valve head portion 76 respectively seats on the first outer valve seat 24, the second outer valve seat 25 and the inner valve seat 26. Every one of the above valve head portions 66, 67, 76 is seated on the valve seat to close the outer and inner injection holes 22, 23, to stop injecting the high-pressure fuel out of the outer and inner injection holes 22, 23, as shown in FIG. 7.

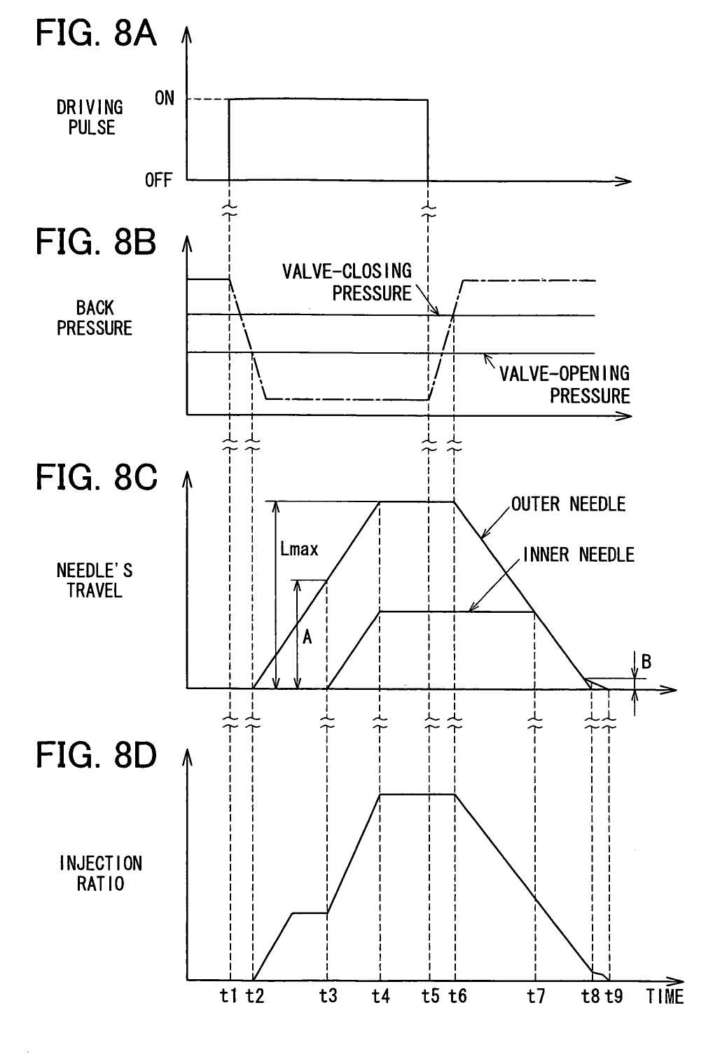

In the following is described an operation of the fuel injection valve 1 in detail, referring to FIGS. 8A to 8D. FIG. 8A depicts a variation of the driving pulse that is sent by the ECU 12 to control an operation of the piezoelectric device 81. FIG. 8B depicts a variation of the backpressure chamber 31. FIG. 8C depicts a variation of traveling distances of the outer and inner needles 6, 7. FIG. 8D depicts a variation of the injection ratio in accordance with the movements of the outer and inner needles 6, 7.

At a time point t1, the ECU 12 starts sending the driving pulse to the piezoelectric device 81 as shown in FIG. 8A. At this time, the piezoelectric device 81 switches the three-way valve 5 from the first position into the second position. Then, the high-pressure fuel in the backpressure chamber 31 returns through the fuel passage 30, the fuel discharge passage 29 and the fuel discharge pipe 15 to the fuel tank 11. As a result, the pressure in the backpressure chamber 31 decreases as shown in FIG. 8B.

At a time point t2, the pressure in the backpressure chamber 31 decreases to a valve-opening pressure, i.e., a pressure at which the needle starts moving toward the counter injection hole side. Thus, the outer needle 6 is subjected to the force to the counter injection hole side, and starts moving to the counter injection hole side as shown in FIG. 4. Then, the first and second outer valve head portions 66, 67 of the outer needle 6 are lifted off the first and second valve seats 24, 25, to start injecting the high-pressure fuel out of the outer injection holes 22.

In the backpressure chamber 31 is installed the inner spring 44, so that the inner valve head portion 76 of the inner needle 7 remains seated on the inner valve seat 26, due to the urging force of the spring 44. At this time, the injection hole-side pressure-receiving surface 71 of the inner needle 7 is subjected to the pressure of the high-pressure fuel led from the nozzle chamber 32. However, the urging force of the inner spring 44 is configured not to move the inner needle 7 to the counter injection hole-side at this time, so that the inner needle 7 does not start moving as shown in FIG. 4.

At a time point t3, the outer needle 6 has moved by a distance as much as the clearance A. That is, the lower end wall 65 of the annular groove 63 of the outer needle 6 collides with the lower surface 75 of the flange 73 of the inner needle 7. Then, as shown in FIG. 5, the outer and inner needles 6, 7 move until the counter injection hole-side pressure-receiving surface 62 of the outer needle 6 comes in contact with the plate surface 41 at a time point t4, keeping the lower end wall 65 of the annular groove 63 and the lower surface 75 of the flange 73 in contact with each other. Accordingly, a relative displacement between the outer and inner needles 6, 7 is limited within a predetermined amount.

In the first embodiment, the annular groove 63 and the flange 73 are formed in the outer and inner needles 6, 7. Therefore, when the outer needle 6 has moved by the distance as much as the clearance A, the inner needle 7 always moves together with the outer needle 6. In the first embodiment, the movement of the inner needle 7 is associated with the movement of the outer needle 6, to stabilize a timing to start moving the inner needle 7 and to realize a demanded injection ratio as shown in FIG. 8D.

The timing to start moving the outer and inner needles 6, 7 can be controlled as demanded by adjusting the clearance A. Thus, it is possible to realize a boot injection pattern, which has a tier in the injection ratio as shown in FIG. 8. The lower end wall 65 of the annular groove 63 and the lower surface 75 of the flange 73 correspond to the opening-side interlock according to the present invention.

At the time point t5, the ECU 12 stops sending the driving pulse to the piezoelectric device 81, to switch the three-way valve 5 back in the second position. Then, the high-pressure fuel in the fuel supply passage 28 is supplied to the backpressure chamber 31 as shown in FIG. 8B.

At the time point t6, the pressure in the backpressure chamber 31 increases to a valve-closing pressure, i.e., a pressure at which the needle starts moving toward the injection hole side. Thus, the outer needle 6 is subjected to the force to the injection hole side, and starts moving to the injection hole side as shown in FIG. 6.

At the time point t7, the outer needle 6 has moved by a distance as much as a sum of the clearance A and the minute clearance B. That is, the upper end wall 64 of the annular groove 63 of the outer needle 6 comes in contact with the upper surface 74 of the flange 73 of the inner needle 7. At this time, the relative displacement between the outer and inner needles 6, 7 is smaller than the relative displacement when the outer and inner needles 6, 7 close the outer and inner injection holes 22, 23 by a distance as much as the minute clearance B. Then, as shown in FIGS. 7, 8C, the outer and inner needles 6, 7 move toward the injection hole side, keeping the upper end wall 64 of the annular groove 63 and the upper surface 74 of the flange 73 in contact with each other as shown in FIG. 7. Accordingly, the relative displacement between the outer and inner needles 6, 7 is limited within a predetermined amount.

At the time point t8, the first and second outer valve head portions 66, 67 seat on the first and second valve seats 24, 25, to stop injecting the high-pressure fuel out of the outer injection holes 22. As described above, a relative displacement between the outer and inner needles 6, 7, i.e., a distance between the outer and inner needle 6, 7 is decreased by the distance as much as the minute clearance B. Thus, the first and second outer valve head portions 66, 67 of the outer needle 6 seat on the first and second valve seats 24, 25 before the inner valve head portion 76 of the inner needle 7 seats on the inner valve seat 26. At the time point t8, the inner valve head portion 76 and the inner valve seat 26 forms a clearance as much as the minute clearance B therebetween. After that, at the time point t9, the inner valve head portion 76 of the inner needle 7 seats on the inner valve seat 26, to stop injecting the high-pressure fuel out of the inner injection holes 23 as shown in FIG. 8C.

In the first embodiment, the annular groove 63 and the flange 73 are formed in the outer and inner needles 6, 7. Therefore, when the outer needle 6 has moved by the distance as much as a sum of the clearance A and the minute clearance B, the inner needle 7 always moves together with the outer needle 6. In the first embodiment, the movement of the inner needle 7 is interlocked with the movement of the outer needle 6, to stabilize the timing to start moving the inner needle 7 and to realize a demanded injection ratio in the latter half stage of the fuel injection operation as shown in FIG. 8D.

By adjusting the minute clearance B, it is possible to seat the outer and inner needles 6, 7 approximately simultaneously with each other on the respective valve seats 24, 25, 26 to close the outer and inner injection holes 22, 23 as shown in FIG. 8D. This action of the outer and inner needles 6, 7 is realized by forming the minute clearance B in a size as small as possible. However, it is desirable that the minute clearance B is enough to absorb dimensional errors and time-lapse variations of the entire lengths of the outer and inner needles 6, 7. The lower end wall 65 of the annular groove 63 and the lower surface 75 of the flange 73 corresponds to the opening-side interlock according to the present invention.

Further, the clearance A is set larger than the minute clearance B in the first embodiment. Accordingly, the injection ratio rapidly drops in the latter half stage of the fuel injection, to stop the fuel injection sharply.

In the first embodiment is described an example in which the outer needle 6 starts moving to the injection hole side in advance of the inner needle 7 in a transition of the outer and inner needles 6, 7 from the opening position to open the outer and inner injection holes 22, 23 to the closing position to close the outer and inner injection holes 22, 23. Alternatively, the fuel injection valve may have a construction that the outer and inner needles 6, 7 integrally move to the injection hole side, keeping the lower end wall 65 of the annular groove 63 in contact with the lower surface 75 of the flange 73.

In this construction, it is desirable that the clearance A is smaller than the clearance B. Accordingly, as described above, the injection ratio rapidly drops in the latter half stage of the fuel injection, to stop the fuel injection sharply.

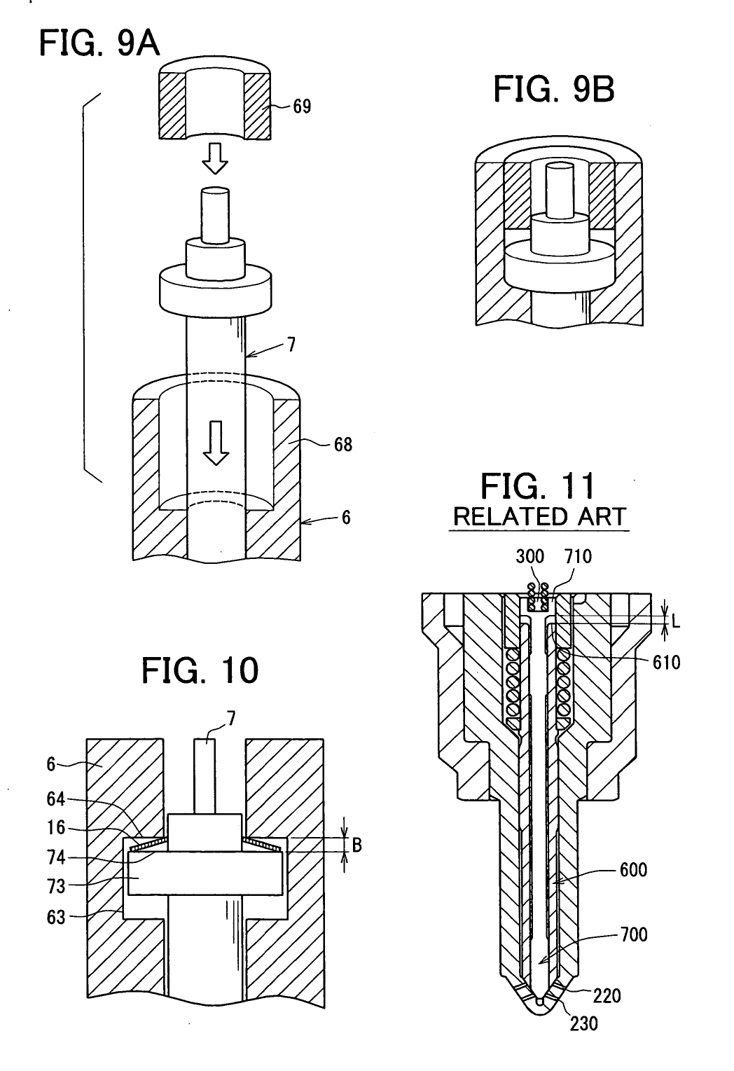

In the following is described a manufacturing method of the fuel injection valve 1 according to the first embodiment of the present invention, referring to FIGS. 9A, 9B. In the following is mainly described an assembly process of the outer and inner needles 6, 7. FIGS. 9A, 9B depict the assembly procedure to install the inner needle 7 into the outer needle 6.

As shown in FIGS. 9A, 9B, the outer needle 6 is formed from at least two parts of: the valve head portion 68 having the first and second outer valve head portions 66, 67; and approximately cylindrically-shaped lid portion 69 having the upper end wall 64 of the annular groove 63 and a portion of the counter injection hole-side pressure-receiving surface 62. An outer diameter of the lid portion 69 is approximately equal to a bore diameter of the bottom of the annular groove 63.

The valve head portion 68 of the outer needle 6 and the lid portion 69 are fixed on each other by interference shrink fitting or press fitting. Here is described a fixing process with interference shrink fitting. As shown in FIGS. 9A, 9B, into the valve head portion 68 of the outer needle 6 is inserted the inner needle 7, on which the flange 73 is integrally formed. Then, heat is added only to the valve head portion 68 of the outer needle 6, to cause thermal expansion in the outer needle 6. The bottom of the annular groove 63 is enlarged in diameter by heating the outer needle 6. At this time, the lid portion 69 is inserted into the valve head portion 68 and then the lid portion 69 is cooled down. The valve head portion 68 and the lid portion 69 are fixed on each other in this manner. Alternatively, the lid portion 69 can be fixed on the valve head portion 68 with press fitting.

By the above-described manufacturing method, it is possible to minimize the number of parts of the outer needle 6, without decreasing a strength of the inner needle 7, which is smaller in diameter than the outer needle 6.

### Second Embodiment

In the following is described a fuel injection valve 1 according to a second embodiment of the present invention, referring to FIG. 10. In the second embodiment, the members to which the same referential numerals are assigned as in the first embodiment have substantially the same functions as those in the first embodiment. In the following is mainly described a construction feature that is different from the first embodiment. FIG. 10 depicts a principal portion of the fuel injection valve 1 in a proximity to the counter injection hole-side end portions of the outer and inner needles 6, 7.

As shown in FIG. 10, a conical spring 16 is installed between the upper end wall 64 of the annular groove 63 of the outer needle 6 and the upper surface 74 of the flange 73 of the inner needle 7. The conical spring 16 corresponds to the elastic member according to the present invention. The conical spring 16 is compressed in a state that the outer and inner injection holes 22, 23 are closed by the outer and inner needles 6, 7.

The conical spring 16 is installed in the clearance B, so that the relative displacement between the outer and inner needles 6, 7, i.e., the axial distance between the outer and inner needles 6, 7 in the closing operation of the outer and inner needles 6, 7, which is from the opening position to open the outer and inner injection holes 22, 23 to the closing position to close the outer and inner injection holes 22, 23, is equal to the relative displacement between the outer and inner needles 6, 7 when the outer and inner needles 6, 7 are closing the outer and inner injection holes 22, 23. That is, the relative displacement between the outer and inner needles 6, 7 does not change between in the opening position to open the outer and inner injection holes 22, 23 and the closing position. Accordingly, the outer and inner needles 6, 7 simultaneously seat on the valve seats 24, 25, 26, to stop the fuel injection out of the outer injection holes 22 and the fuel injection out of the inner injection holes 23 at the same time.

The conical spring 16 installed in the clearance B has elasticity, so that the conical spring 16 can absorb the dimensional errors and time-lapse variations of the entire lengths of the outer and inner needles 6, 7.

The elastic member according to the present invention is not limited to the conical spring 16. The elastic member can be served by any member that can be elastically deformed in a compressed direction to fine-adjust the distance between the outer and inner needles 6, 7 in the axial direction. Rubbers and soft metals, for example, can serve as the elastic member according to the present invention.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fluid injection valve comprising:
a valve body that has an outer injection hole and an inner injection hole respectively for injecting fluid therefrom;
an outer needle that is installed in the valve body to slide in an axial direction to open and close the outer injection hole;
an inner needle that is installed in a longitudinal bore of the outer needle in the axial direction to open and close the inner injection hole;
a backpressure chamber that accumulates a backpressure acting on the outer and inner needles; and
a pressure control valve that regulates the backpressure to control movements of the outer and inner needles,
wherein the outer needle and the inner needle has an opening-side interlock and a closing-side interlock, the opening-side interlock engaging the outer needle with the inner needle to limit a relative displacement between the outer and inner needles within a first predetermined distance during an opening operation of the outer and inner needles from a closing position to close the outer and inner injection holes to an opening position to open the outer and inner injection holes, and the closing-side interlock engaging the outer needle with the inner needle to limit the relative displacement between the outer and inner needles within a second predetermined distance during a closing operation of the outer and inner needles from the opening position to the closing position.

2. The fluid injection valve according to claim 1, wherein:
the opening-side interlock has a first play; and
the closing-side interlock has a second play.

3. The fluid injection valve according to claim 2, wherein:
the outer and inner needles are configured so that the outer needle starts moving toward the outer injection hole before the inner needle starts moving toward the inner injection hole in the opening operation of the outer and inner needles; and
the first play is larger than the second play.

4. The fluid injection valve according to claim 2, wherein:
the outer and inner needles are configured so that the outer needle starts moving toward the outer injection hole simultaneously as the inner needle starts moving toward the inner injection hole in the opening operation of the outer and inner needles; and
the first play is smaller than the second play.

5. The fluid injection valve according to claim 2, further comprising an elastic member that is installed in a clearance of the second play.

6. The fluid injection valve according to claim 1, wherein:
the outer needle has a depression that is formed on an inner circumferential surface of the longitudinal bore thereof, the depression having a first and second axial end interior surfaces facing in the axial direction;
the inner needle has a protrusion that protrudes from an outer circumferential surface thereof to be engaged with the depression of the outer needle, the protrusion having a first and second axial end surfaces;
the opening-side interlock includes the first axial end interior surface of the depression and the first axial end surface of the protrusion; and
the closing-side interlock includes the second axial end interior surface of the depression and the second axial end surface of the protrusion.

7. The fluid injection valve according to claim 6, wherein:
the depression is formed in a counter injection hole-side end portion of the outer needle; and
the protrusion is formed in a counter injection hole-side end portion of the inner needle.

8. The fluid injection valve according to claim 6, wherein the outer needle includes:
an outer needle body that has a small diameter bore and a large diameter bore; and
a cylindrically-shaped outer needle attachment that is press-fitted in the large diameter bore of the outer needle body to form the depression between the small diameter bore of the outer needle body and the outer needle attachment.
